(19) United States
(12) Patent Application Publication
(10) Pub. No.: US 2024/0237133 A1
(43) Pub. Date: Jul. 11, 2024

(54) CELL DISCONTINUOUS TRANSMISSION AND RECEPTION

(71) Applicant: Samsung Electronics Co., Ltd., Suwon-si (KR)

(72) Inventors: Jeongho Jeon, San Jose, CA (US); Aristides Papasakellariou, Houston, TX (US); Hongbo Si, Allen, TX (US)

(21) Appl. No.: 18/396,519

(22) Filed: Dec. 26, 2023

Related U.S. Application Data
(60) Provisional application No. 63/437,899, filed on Jan. 9, 2023.
(60) Provisional application No. 63/446,694, filed on Feb. 17, 2023.
(60) Provisional application No. 63/538,630, filed on Sep. 15, 2023.
(60) Provisional application No. 63/540,568, filed on Sep. 26, 2023.

(51) Int. Cl. H04W 76/28; H04L 5/00

(52) U.S. Cl. CPC H04W 76/28; H04L 5/0053

(57) ABSTRACT

Methods and apparatuses for cell discontinuous transmission (DTX) and discontinuous reception (DRX). A method performed by a user equipment (UE) includes receiving information related to set(s) of parameters associated with cell DTX or cell DRX on a cell and an indication for activation or deactivation of the cell DTX or the cell DRX. The set(s) of parameters include a cycle, a start offset, or an on-duration timer. The cell DTX and the cell DRX share common parameters. The method further comprises determining an active period and a non-active period of the cell DTX or the cell DRX based on the indication for activation or deactivation, determining a start of the cell DTX or DRX on-duration timer based on a system frame number (SFN), and receiving or transmitting channels or signals on the cell based on the determined active and non-active periods of the cell DTX or the cell DRX, respectively.

### CROSS-REFERENCE TO RELATED APPLICATION AND CLAIM OF PRIORITY

This application claims priority under 35 U.S.C. § 119(e) to U.S. Provisional Patent Application No. 63/437,899 filed on Jan. 9, 2023, U.S. Provisional Patent Application No. 63/446,694 filed on Feb. 17, 2023, U.S. Provisional Patent Application No. 63/538,630 filed on Sep. 15, 2023, and U.S. Provisional Patent Application No. 63/540,568 filed on Sep. 26, 2023. The above-identified provisional patent applications are hereby incorporated by reference in its entirety.

### TECHNICAL FIELD

The present disclosure relates generally to wireless communication systems and, more specifically, relates to cell discontinuous transmission (DTX) and discontinuous reception (DRX).

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure relates to cell DTX and DRX.

In an embodiment, a method performed by a user equipment (UE) is provided. The method includes receiving information related to one or more sets of parameters associated with cell DTX or cell DRX on a cell and an indication for activation or deactivation of the cell DTX or the cell DRX. The one or more sets of parameters include a cycle, a start offset, or an on-duration timer. The cell DTX and the cell DRX share common parameters. The method further comprises determining an active period and a non-active period of the cell DTX based on the indication for activation or deactivation of cell DTX or an active period and a non-active period of the cell DRX based on the indication for activation or deactivation of cell DRX, determining a start of the cell DTX or DRX on-duration timer based on a system frame number (SFN), and one of receiving channels or signals on the cell based on the determined active and non-active periods of the cell DTX or transmitting channels or signals on the cell based on the determined active and non-active periods of the cell DRX.

In another embodiment, a UE is provided. The UE includes a transceiver configured to receive information related to one or more sets of parameters associated with cell DTX or cell DRX on a cell and an indication for activation or deactivation of the cell DTX or the cell DRX. The one or more sets of parameters include a cycle, a start offset, or an on-duration timer. The cell DTX and the cell DRX share common parameters. The UE further includes a processor operably coupled to the transceiver. The processor configured to determine an active period and a non-active period of the cell DTX based on the indication for activation or deactivation of cell DTX or an active period and a non-active period of the cell DRX based on the indication for activation or deactivation of cell DRX and determine a start of the cell DTX or DRX on-duration timer based on a SFN. The transceiver is further configured to receive channels or signals on the cell based on the determined active and non-active periods of the cell DTX or transmit channels or signals on the cell based on the determined active and non-active periods of the cell DRX.

In yet another embodiment, a base station (BS) is provided. The BS includes a transceiver configured to transmit information related to one or more sets of parameters associated with cell DTX or cell DRX on a cell and an indication for activation or deactivation of the cell DTX or the cell DRX. The one or more sets of parameters include a cycle, a start offset, or an on-duration timer. The cell DTX and the cell DRX share common parameters. The BS further includes a processor operably coupled to the transceiver. The processor is configured to determine an active period and a non-active period of the cell DTX based on the indication for activation or deactivation of cell DTX or an active period and a non-active period of the cell DRX based on the indication for activation or deactivation of cell DRX and determining a start of the cell DTX or DRX on-duration timer based on a SFN. The transceiver is further configured to transmit channels or signals on the cell based on the determined active and non-active periods of the cell DTX or receive channels or signals on the cell based on the determined active and non-active periods of the cell DRX.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example base station according to embodiments of the present disclosure;

FIG. 3 illustrates an example user equipment (UE) according to embodiments of the present disclosure;

FIGS. 4A-B illustrate example wireless transmit and receive paths according to embodiments of the present disclosure;

FIG. 5 illustrates a block diagram of an example transmitter structure using OFDM according to embodiments of the present disclosure;

FIG. 6 illustrates a block diagram of an example receiver structure using OFDM according to embodiments of the present disclosure;

FIG. 7 illustrates a block diagram of an example encoding process for a DCI format according to embodiments of the present disclosure;

FIG. 8 illustrates a block diagram of an example decoding process for a DCI format for use with a UE according to embodiments of the present disclosure;

FIG. 9 illustrates a diagram of DCI-based network (NW) operation state transition according to embodiments of the present disclosure;

FIG. 10 illustrates a diagram of an example cell DTX/DRX configuration according to embodiments of the present disclosure;

FIG. 11 illustrates a diagram of separate configurations for cell DTX/DRX according to embodiments of the present disclosure;

FIG. 12 illustrates a diagram of cell DTX/DRX and UE DRX interaction according to embodiments of the present disclosure;

FIG. 13 illustrates a diagram of a UE Wake-UP during cell DTX/DRX according to embodiments of the present disclosure;

FIG. 14 illustrates a diagram of UE short DRX handling according to embodiments of the present disclosure;

FIG. 15 illustrates a diagram of handling HARQ RTT and DRX retransmission timers according to embodiments of the present disclosure; and

FIG. 16 illustrates a flowchart for a method performed by a UE according to embodiments of the present disclosure.

### DETAILED DESCRIPTION

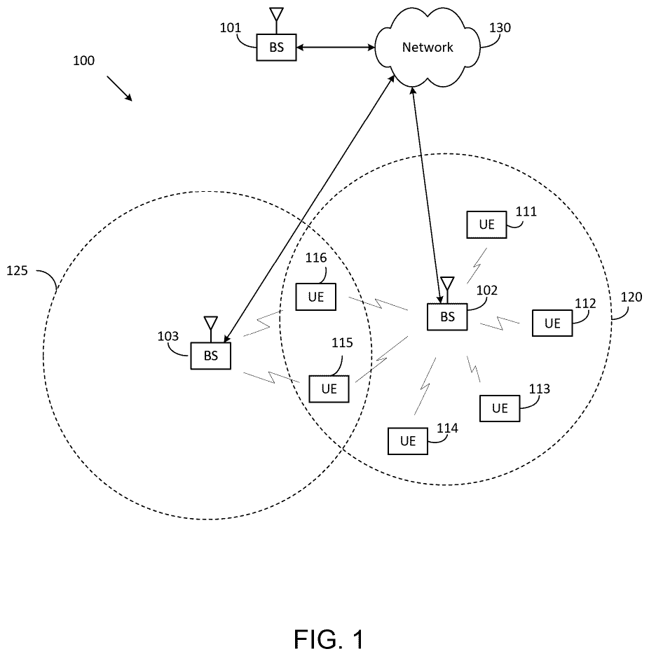

FIGS. 1 through 16, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

The following documents and standards descriptions are hereby incorporated by reference into the present disclosure as if fully set forth herein.: 3GPP TS 38.211 v17.2.0, “NR; Physical channels and modulation” (REF1); 3GPP TS 38.212 v17.2.0, “NR; Multiplexing and Channel coding” (REF2); 3GPP TS 38.213 v17.2.0, “NR; Physical Layer Procedures for Control” (REF3); 3GPP TS 38.214 v17.2.0, “NR; Physical Layer Procedures for Data” (REF4); 3GPP TS 38.321 v17.1.0, “NR; Medium Access Control (MAC) protocol specification” (REF5); 3GPP TS 38.331 v17.1.0, “NR; Radio Resource Control (RRC) Protocol Specification” (REF6); and 3GPP TS 36.211 v17.1.0, “NR; Physical channels and modulation” (REF 7).

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof to facilitate or support cell discontinuous transmission and reception. Additionally, one or more of the BSs 101-103 include circuitry, programing, or a combination thereof to facilitate or support cell discontinuous transmission and reception.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

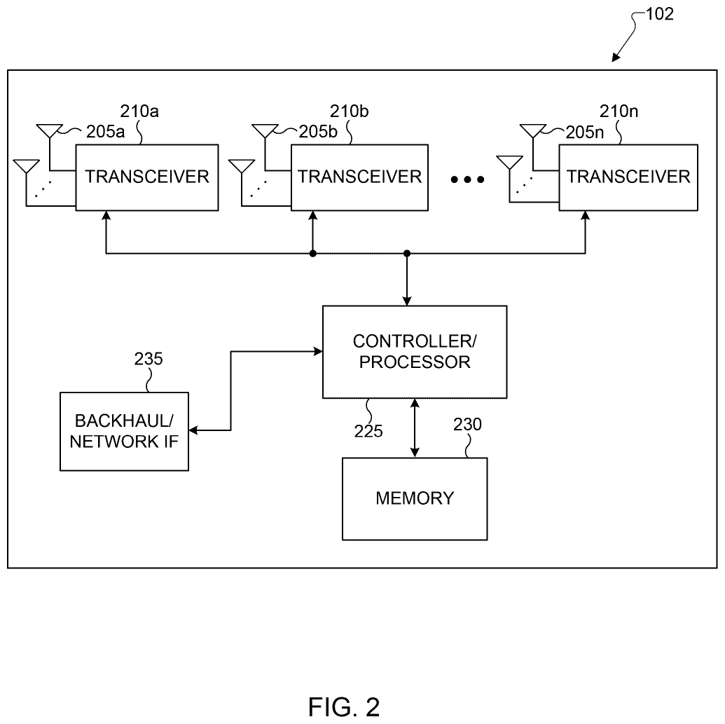

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235. In embodiments, the controller/processor 225 is configured to execute instructions to facilitate cell discontinuous transmission and reception using one or more of the multiple antennas 205a-205n and one or more of the multiple transceivers 210a-210n.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

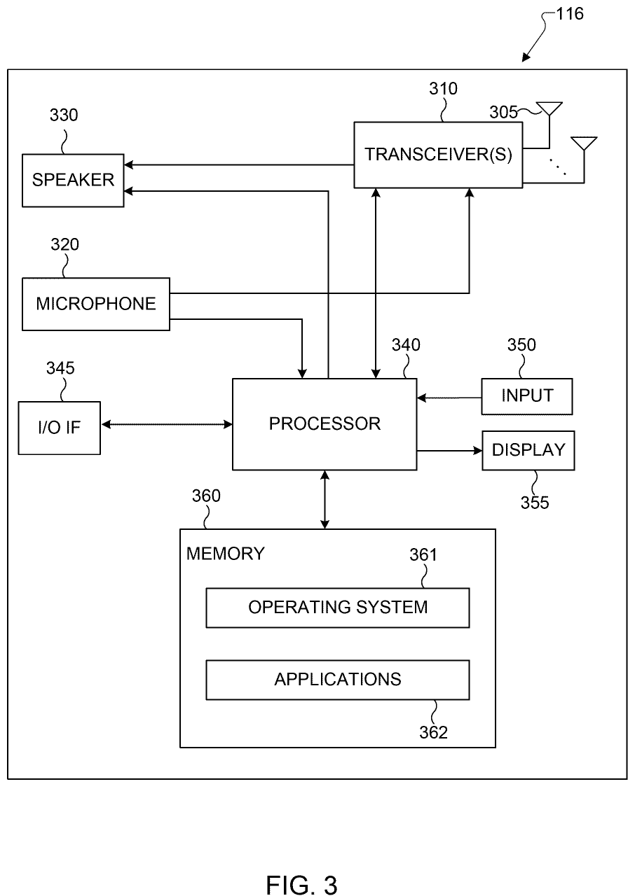

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362. In embodiments, the processor 340 is configured to execute instructions to support cell discontinuous transmission and reception using the antenna(s) 305 and the transceiver(s) 210.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

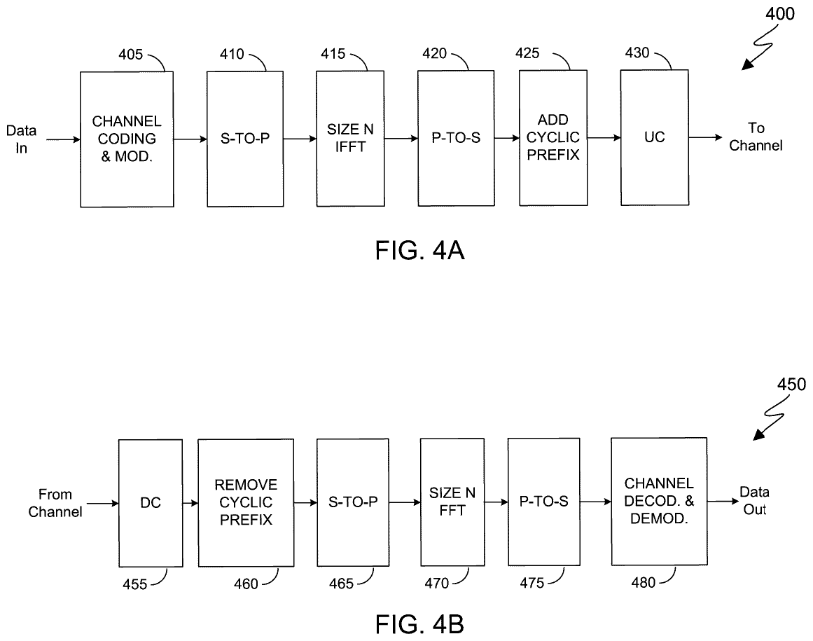

FIGS. 4A and 4B illustrate example wireless transmit and receive paths according to this disclosure. In the following description, a transmit path 400 may be described as being implemented in an gNB (such as gNB 104), while a receive path 450 may be described as being implemented in a UE (such as UE 116). However, it will be understood that the receive path 450 can be implemented in an gNB and that the transmit path 400 can be implemented in a UE. In embodiments, the transmit path 400 and the receive path 450 are each configured to support and facilitate cell discontinuous transmission and reception.

The transmit path 400 includes a channel coding and modulation block 405, a serial-to-parallel (S-to-P) block 410, a size N Inverse Fast Fourier Transform (IFFT) block 415, a parallel-to-serial (P-to-S) block 440, an add cyclic prefix block 445, and an up-converter (UC) 430. The receive path 450 includes a down-converter (DC) 455, a remove cyclic prefix block 460, a serial-to-parallel (S-to-P) block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 104 and the UE 116. The size N IFFT block 415 performs an IFFT operation on the N parallel symbol streams to generate time-domain output signals. The parallel-to-serial block 440 converts (such as multiplexes) the parallel time-domain output symbols from the size N IFFT block 415 in order to generate a serial time-domain signal. The add cyclic prefix block 445 inserts a cyclic prefix to the time-domain signal. The up-converter 430 modulates (such as up-converts) the output of the add cyclic prefix block 445 to an RF frequency for transmission via a wireless channel. The signal may also be filtered at baseband before conversion to the RF frequency.

A transmitted RF signal from the gNB 104 arrives at the UE 116 after passing through the wireless channel, and reverse operations to those at the gNB 104 are performed at the UE 116. The down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time domain signals. The size N FFT block 470 performs an FFT algorithm to generate N parallel frequency-domain signals. The parallel-to-serial block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 4, 3, 4, or the like) for DFT and IDFT functions, while the value of the variable N may be any integer number that is a power of two (such as 1, 4, 4, 8, 16, or the like) for FFT and IFFT functions.

Although FIGS. 4A and 4B illustrate examples of wireless transmit and receive paths, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In the following, an italicized name for a parameter implies that the parameter is provided by higher layers.

DL transmissions or UL transmissions can be based on an OFDM waveform including a variant using DFT precoding that is known as DFT-spread-OFDM that is typically applicable to UL transmissions.

In the following, subframe (SF) refers to a transmission time unit for the LTE RAT and slot refers to a transmission time unit for an NR RAT. For example, the slot duration can be a sub-multiple of the SF duration. NR can use a different DL or UL slot structure than an LTE SF structure. Differences can include a structure for transmitting physical downlink control channels (PDCCHs), locations and structure of demodulation reference signals (DM-RS), transmission duration, and so on. Further, eNB refers to a base station serving UEs operating with LTE RAT and gNB refers to a base station serving UEs operating with NR RAT. Exemplary embodiments consider a same numerology, that includes a sub-carrier spacing (SCS) configuration and a cyclic prefix (CP) length for an OFDM symbol, for transmission with LTE RAT and with NR RAT. In such case, OFDM symbols for the LTE RAT as same as for the NR RAT, a subframe is same as a slot and, for brevity, the term slot is subsequently used in the remaining of the disclosure.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. A sub-carrier spacing (SCS) can be determined by a SCS configuration y as 2-15 kHz. A unit of one sub-carrier over one symbol is referred to as resource element (RE). A unit of one RB over one symbol is referred to as physical RB (PRB).

DL signaling include physical downlink shared channels (PDSCHs) conveying information content, PDCCHs conveying DL control information (DCI), and reference signals (RS). A PDCCH can be transmitted over a variable number of slot symbols including one slot symbol and over a number of control channel elements (CCEs) from a predetermined set of numbers of CCEs referred to as CCE aggregation level within a control resource set (CORESET) as described in REF7 and REF3.

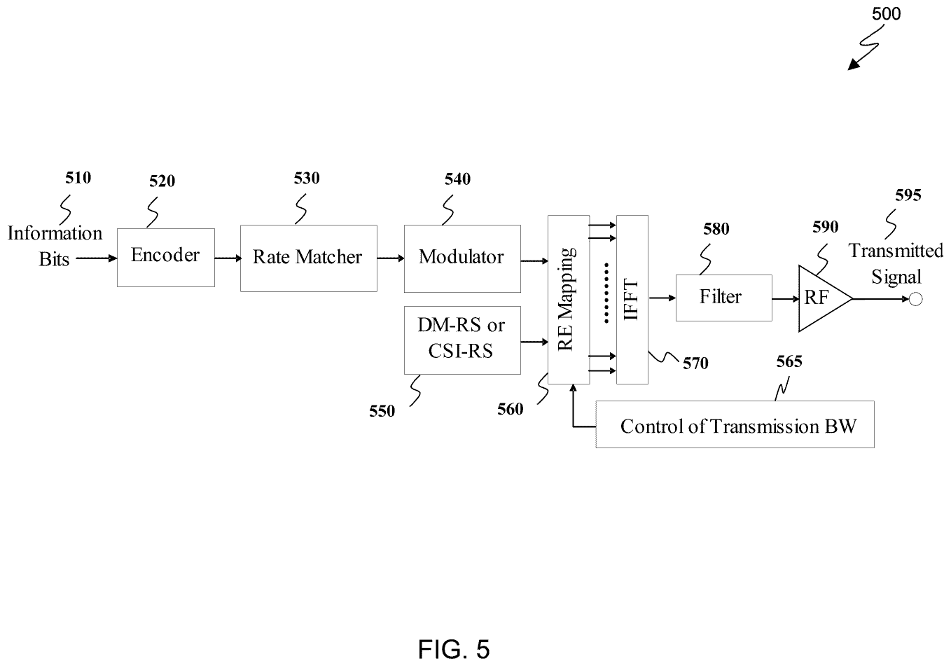

FIG. 5 illustrates a block diagram of an example transmitter structure 500 using OFDM according to this disclosure. The embodiment of the example transmitter structure 500 illustrated in FIG. 5 is for illustration only. FIG. 5 does not limit the scope of this disclosure to any particular implementation of the example transmitter structure 500.

Information bits, such as DCI bits or data bits 510, are encoded by encoder 520, rate matched to assigned time/frequency resources by rate matcher 530, and modulated by modulator 540. Subsequently, modulated encoded symbols and DM-RS or CSI-RS 550 are mapped to REs 560 by RE mapping unit 565, an inverse fast Fourier transform (IFFT) is performed by filter 570, a cyclic prefix (CP) is added by CP insertion unit 580, and a resulting signal is filtered by filter 590 and transmitted by a radio frequency (RF) unit 595. In embodiments, the transmitter structure 500 may be used to support cell discontinuous transmission and reception.

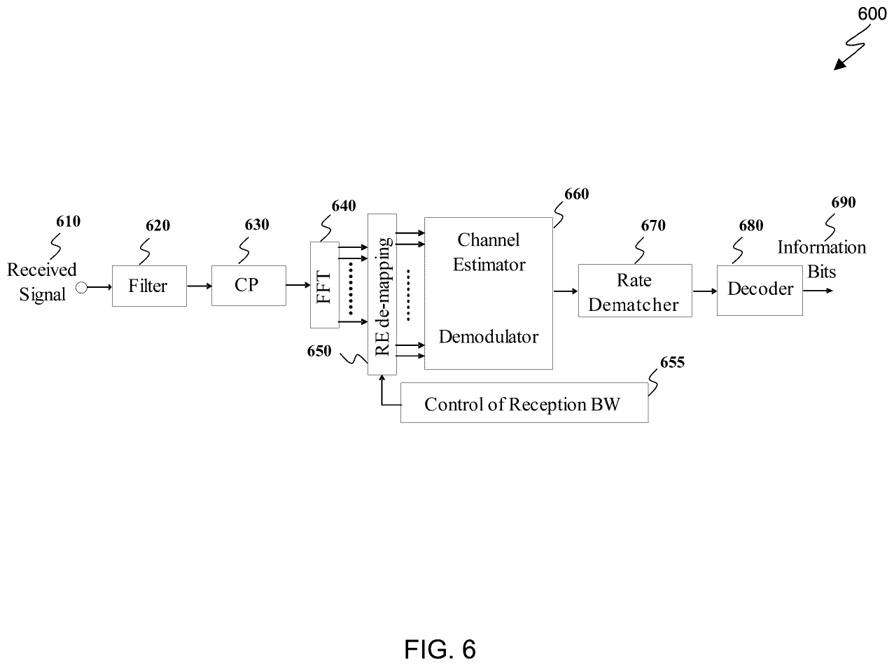

FIG. 6 illustrates a block diagram of an example receiver structure 600 using OFDM according to this disclosure. The embodiment of the example receiver structure 600 illustrated in FIG. 6 is for illustration only. FIG. 6 does not limit the scope of this disclosure to any particular implementation of the example receiver structure 600.

A received signal 610 is filtered by filter 620, a CP removal unit removes a CP 630, a filter 640 applies a fast Fourier transform (FFT), RE de-mapping unit 650 de-maps REs selected by BW selector unit 655, received symbols are demodulated by a channel estimator and a demodulator unit 660, a rate de-matcher 670 restores a rate matching, and a decoder 680 decodes the resulting bits to provide information bits 690. In embodiments, the receiver structure 600 may be used to support cell discontinuous transmission and reception.

DCI can serve several purposes. A DCI format includes information elements (IEs) and is typically used for scheduling a PDSCH (DL DCI format) or a PUSCH (UL DCI format) transmission. A DCI format includes cyclic redundancy check (CRC) bits in order for a UE to confirm a correct detection. A DCI format type is identified by a radio network temporary identifier (RNTI) that scrambles the CRC bits. For a DCI format scheduling a PDSCH or a PUSCH for a single UE with RRC connection to a gNB, the RNTI is a cell RNTI (C-RNTI) or another RNTI type such as a MCS-C-RNTI. For a DCI format scheduling a PDSCH conveying system information (SI) to a group of UEs, the RNTI is a SI-RNTI. For a DCI format scheduling a PDSCH providing a response to a random access (RA) from a group of UEs, the RNTI is a RA-RNTI. For a DCI format scheduling a PDSCH providing contention resolution in Msg4 of a RA process, the RNTI is a temporary C-RNTI (TC-RNTI). For a DCI format scheduling a PDSCH paging a group of UEs, the RNTI is a P-RNTI. For a DCI format providing transmission power control (TPC) commands to a group of UEs, the RNTI is a TPC-RNTI, and so on. Each RNTI type is configured to a UE through higher layer signaling. A UE typically decodes at multiple candidate locations for potential PDCCH transmissions.

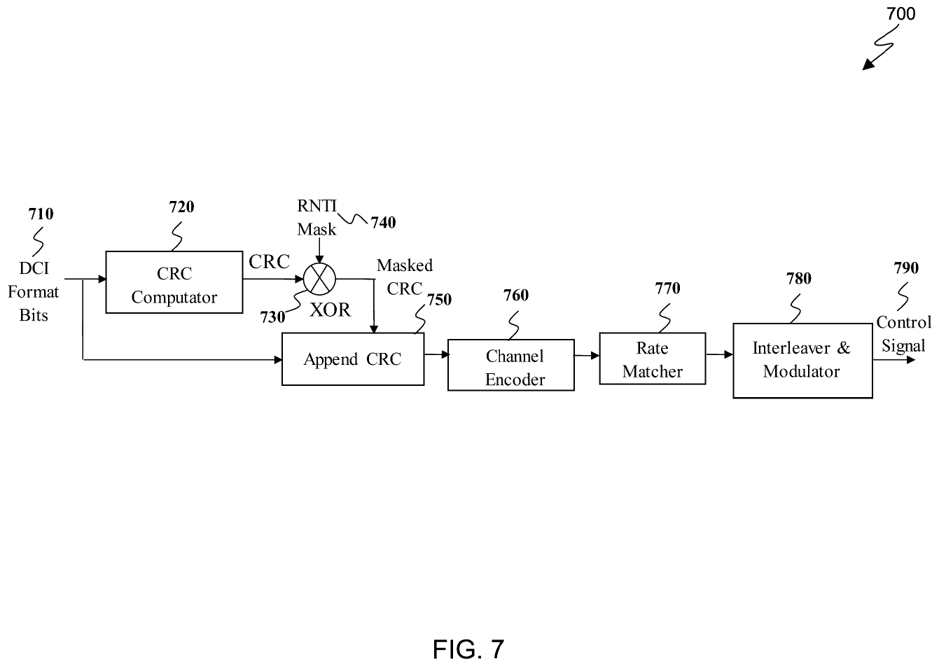

FIG. 7 illustrates a block diagram of an example encoding process 700 for a DCI format according to this disclosure. The embodiment of the example encoding process 700 illustrated in FIG. 7 is for illustration only. FIG. 7 does not limit the scope of this disclosure to any particular implementation of the example encoding process 700.

A gNB separately encodes and transmits each DCI format in a respective PDCCH. When applicable, a RNTI for a UE that a DCI format is intended for masks a CRC of the DCI format codeword in order to enable the UE to identify the DCI format. For example, the CRC can include 24 bits and the RNTI can include 16 bits or 24 bits. The CRC of (non-coded) DCI format bits 710 is determined using a CRC computation unit 720, and the CRC is masked using an exclusive OR (XOR) operation unit 730 between CRC bits and RNTI bits 740. The XOR operation is defined as XOR(0,0)=0, XOR(0,1)=1, XOR(1,0)=1, XOR(1,1)=0. The masked CRC bits are appended to DCI format information bits using a CRC append unit 750. An encoder 760 performs channel coding, such as polar coding, followed by rate matching to allocated resources by rate matcher 770. Interleaving and modulation units 780 apply interleaving and modulation, such as QPSK, and the output control signal 790 is transmitted. In embodiments, the encoding process 700 may be used to support cell discontinuous transmission and reception.

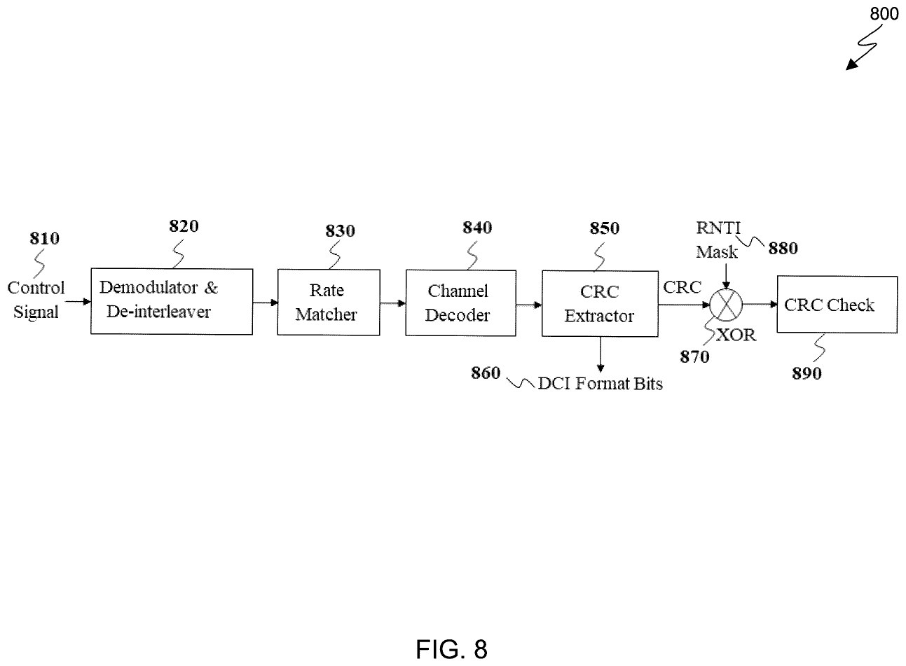

FIG. 8 illustrates a block diagram of an example decoding process 800 for a DCI format for use with a UE according to this disclosure. The embodiment of the example decoding process 800 illustrated in FIG. 8 is for illustration only. FIG. 8 does not limit the scope of this disclosure to any particular implementation of the example decoding process 800.

A received control signal 810 is demodulated and de-interleaved by a demodulator and a de-interleaver 820. A rate matching applied at a gNB transmitter is restored by rate matcher 830, and resulting bits are decoded by decoder 840. After decoding, a CRC extractor 850 extracts CRC bits and provides DCI format information bits 860. The DCI format information bits are de-masked 870 by an XOR operation with a RNTI 880 (when applicable) and a CRC check is performed by unit 890. When the CRC check succeeds (check-sum is zero), the DCI format information bits are considered to be valid. When the CRC check does not succeed, the DCI format information bits are considered to be invalid. In embodiments, the decoding process 800 may be used to support cell discontinuous transmission and reception.

For each DL bandwidth part (BWP) indicated to a UE in a serving cell, the UE can be provided by higher layer signaling with P<3 control resource sets (CORESETs). For each CORESET, the UE is provided a CORESET index p, 0≤p<12, a DM-RS scrambling sequence initialization value, a precoder granularity for a number of resource element groups (REGs) in the frequency domain where the UE can assume use of a same DM-RS precoder, a number of consecutive symbols for the CORESET, a set of resource blocks (RBs) for the CORESET, CCE-to-REG mapping parameters, an antenna port quasi co-location, from a set of antenna port quasi co-locations, indicating quasi co-location information of the DM-RS antenna port for PDCCH reception in a respective CORESET, and an indication for a presence or absence of a transmission configuration indication (TCI) field for DCI format 1_1 transmitted by a PDCCH in CORESET p.

For each DL BWP configured to a UE in a serving cell, the UE is provided by higher layers with S≤10 search space sets. For each search space set from the S search space sets, the UE is provided a search space set index s, 0≤s<40, an association between the search space set s and a CORESET p, a PDCCH monitoring periodicity of kₛ slots and a PDCCH monitoring offset of oₛ slots, a PDCCH monitoring pattern within a slot, indicating first symbol(s) of the CORESET within a slot for PDCCH monitoring, a duration of Tₛ<kₛ slots indicating a number of slots that the search space set s exists, a number of PDCCH candidates M(S^{L}) per CCE aggregation level L, and an indication that search space set s is either a CSS set or a USS set. When search space set s is a CSS set, the UE monitors PDCCH for detection of DCI format 2_x, where x ranges from 0 to 7 as described in REF2, or for DCI formats associated with scheduling broadcast/multicast PDSCH receptions, and possibly for DCI format 0_0 and DCI format 1_0.

A UE determines a PDCCH monitoring occasion on an active DL BWP from the PDCCH monitoring periodicity, the PDCCH monitoring offset, and the PDCCH monitoring pattern within a slot. For search space set s, the UE determines that a PDCCH monitoring occasion(s) exists in a slot with number nₛ, in a frame with number n_{f} if (n_{f}·Nₛₗₒₜ^{frame,μ}+n_{s,f}^{μ}−oₛ) mod kₛ=0. The UE monitors PDCCH candidates for search space set s for Tₛ consecutive slots, starting from slot n_{s,f}^{μ}, and does not monitor PDCCH candidates for search space set s for the next kₛ−Tₛ consecutive slots. The UE determines CCEs for monitoring PDCCH according to a search space set based on a search space equation as described in REF3.

A UE expects to monitor PDCCH candidates for up to 4 sizes of DCI formats that include up to 3 sizes of DCI formats with CRC scrambled by C-RNTI per serving cell. The UE counts a number of sizes for DCI formats per serving/scheduled cell based on a number of PDCCH candidates in respective search space sets for the corresponding active DL BWP. In the following, for brevity, that constraint for the number of DCI format sizes will be referred to as DCI size limit. When the DCI size limit would be exceeded for a UE based on a configuration of DCI formats that the UE monitors PDCCH, the UE aligns the size of some DCI formats, as described in REF2, so that the DCI size limit would not be exceeded.

For each scheduled cell, the UE is not required to monitor on the active DL BWP with SCS configuration y of the scheduling cell more than min(M_{PDCCH}^{max,slot,μ},M_{PDCCH}^{total,slot,μ}) candidates or more than min (C_{PDCCH}^{max,slot,μ},C_{PDCCH}^{total,slot,μ}) non-overlapped CCEs per slot wherein M_{PDCCH}^{max,slot,μ} and C_{PDCCH}^{max,slot,μ} are respectively a maximum number of PDCCH candidates and non-overlapping CCEs for a scheduled cell and M_{PDCCH}^{total,slot,μ} and C_{PDCCH}^{total,slot,μ} are respectively a total number of PDCCH candidates and non-overlapping CCEs for a scheduling cell, as described in REF3.

A UE does not expect to be configured CSS sets, other than CSS sets for multicast PDSCH scheduling, that result to corresponding total, or per scheduled cell, numbers of monitored PDCCH candidates and non-overlapped CCEs per slot on the primary cell that exceed the corresponding maximum numbers per slot. For USS sets or for CSS sets associated with multicast PDSCH scheduling, when a number of PDCCH candidates or non-overlapping CCEs in a slot would exceed the aforementioned limits/maximum per slot for scheduling on the primary cell, the UE selects the USS sets or the CSS sets to monitor corresponding PDCCH in an ascending order of a corresponding search space set index until and an index of a search space set for which PDCCH monitoring would result to exceeding the maximum number of PDCCH candidates or non-overlapping CCEs per slot for scheduling on the PCell as described in REF3.

For same cell scheduling or for cross-carrier scheduling where a scheduling cell and scheduled cells have DL BWPs with same SCS configuration y, a UE does not expect a number of PDCCH candidates, and a number of corresponding non-overlapped CCEs per slot on a secondary cell to be larger than the corresponding numbers that the UE is capable of monitoring on the secondary cell per slot. For cross-carrier scheduling, the number of PDCCH candidates for monitoring and the number of non-overlapped CCEs per slot are separately counted for each scheduled cell.

A UE can be configured for operation with carrier aggregation (CA) for PDSCH receptions over multiple cells (DL CA) or for PUSCH transmissions over multiple cells (UL CA). The UE can also be configured multiple transmission-reception points (TRPs) per cell via indication (or absence of indication) of a coresetPoolIndex for CORESETs where the UE receives PDCCH/PDSCH from a corresponding TRP as described in REF3 and REF4.

Present networks have limited capability to adapt an operation state in one or more of time/frequency/spatial/power domains. For example, in NR, there are transmissions or receptions by a serving gNB that are expected by UEs, such as transmissions of SS/PBCH blocks or system information or CSI-RS indicated by higher layers, or receptions of PRACH or SRS indicated by higher layers. Reconfiguration of a NW operation state involves higher layer signaling by a SIB or by UE-specific RRC. That is a slow process and requires substantial signaling overhead, particularly for UE-specific RRC signaling. For example, it is currently not practical or possible for a network in typical deployments to enter an energy saving state where the network does not transmit or receive due to low traffic as, in order to obtain material energy savings, the network needs to suspend transmissions or receptions for several tens of milliseconds and preferably for even longer time periods. A similar inability exists for suspending transmissions or receptions for shorter time periods as a serving gNB may need to transmit SS/PBCH blocks every 5 msec and, in TDD systems with UL-DL configurations having few UL symbols in a period, the serving gNB may need to receive PRACH or SRS in most UL symbols in a period.

Due to the above reasons, adaptation of a NW operation state is typically over long time periods, such as for off-peak hours when an amount of served traffic is small and for peak hours when an amount of served traffic is large. Therefore, a capability of a gNB to improve service by fast adaptation of a NW operation state to the traffic types and load, or to save energy by switching to a state that requires less energy consumption when an impact on service quality would be limited or none, is currently limited as there are no procedures for a serving gNB to perform fast adaptation of a NW operation state, with small signaling overhead, while simultaneously informing all UEs.

It is also beneficial to support a gradual transition of NW operation states between a maximum state where the NW operates at its maximum capability in one or more of a time/frequency/spatial/power domain and a minimum state where the NW operates at its minimum capability, or the NW enters a sleep mode. That would allow continuation of service while the NW transitions from a state with larger utilization of time/frequency/spatial/power resources to a state with lower utilization of such resources and the reverse as UEs can obtain time/frequency synchronization and automatic gain controller (AGC) alignments, perform measurements and provide CSI reports or transmit SRS prior to scheduling of PDSCH receptions or PUSCH transmissions.

Fast information exchange between a serving gNB and UEs can be achieved by physical layer signaling and, when a group of UEs or all UEs need to be informed, that physical layer signaling can be provided by control information that is commonly received by the UEs. Therefore, a serving gNB can utilize a PDCCH transmission to provide a DCI format with information about an adaptation of a NW operation state, which is referred to as DCI format 2_9. For example, in present deployments, such a DCI format is a DCI format 2_0 with information that adapts a TDD UL-DL configuration as described in TS 38.213 v17.2.0, or a DCI format 2_1, 2_2, 23, 2_4, 2_6, and 2_7 with information that adapts UE transmissions or receptions as described in TS 38.213 v17.2.0. As a UE can be configured for operation over multiple cells, such as for operation with carrier aggregation or dual connectivity, it is beneficial that a DCI format indicates NW operation states for multiple cells.

PDCCHs providing DCI format 29 indicating NW operation states may not be possible for a NW to transmit according to corresponding search space sets, for example when the NW is in a sleep state or transitions to a sleep state. To support such operation, it is beneficial for the DCI format 2_9 to also indicate to UEs a next monitoring occasion for PDCCHs providing the DCI format indicating NW operation states.

There can also be cases where a UE cannot monitor PDCCH for detection of a DCI format 2_9 indicating NW operation states, particularly when a periodicity of such PDCCH monitoring is long, and it would be then beneficial for a NW to also indicate NW operation states by a DCI format 2_9 that a UE monitors corresponding PDCCHs according to USS sets.

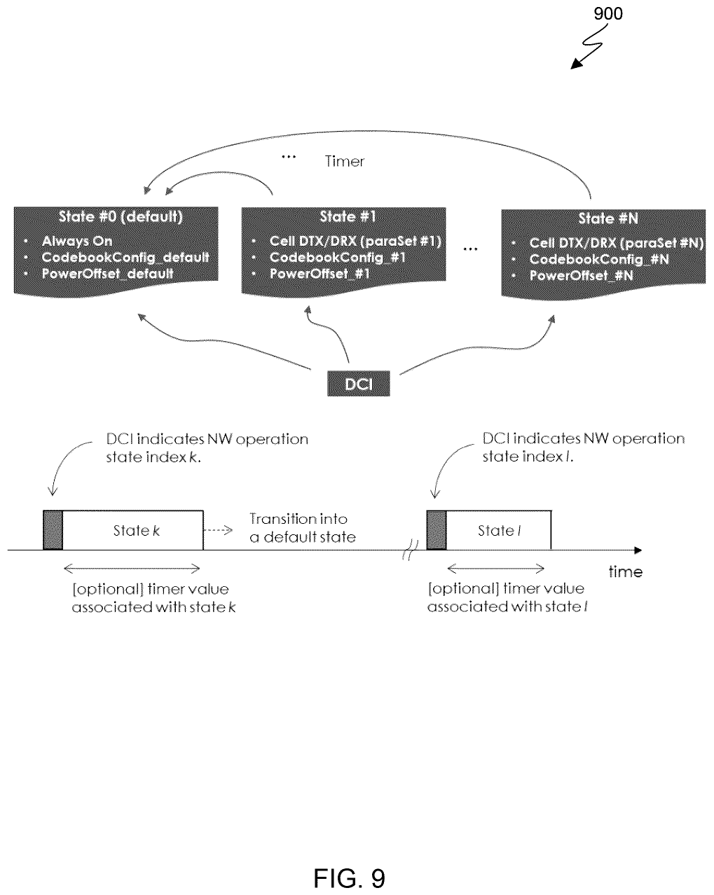

FIG. 9 illustrates a diagram 900 of DCI-based NW operate state transition. The diagram 900 of FIG. 9 can be implemented as an example method for configuring one or multiple network operation states using higher-layer signaling and triggering network state transition using DCI indicating network operation state index. The embodiment of the diagram 900 illustrated in FIG. 9 is for illustration only. FIG. 9 does not limit the scope of this disclosure to any particular implementation of the diagram 900.

A network operation state is defined as a set of network operation parameters, such that cell DTX/DRX, spatial domain adaptation, and power domain adaptation can be jointly configured. Multiple network operation states can be configured via higher-layer signaling and the state index can be indicated in the DCI.

A UE (e.g., UE 116) can be configured with a network operation state, incorporating the adaptation from cell DTX/DRX, spatial domain solution, and power domain solution, as well as other energy saving enhancements in the future. The followings are examples of possible network operation state configuration: Example 1: A network operation state can be associated with an active/non-active period of cell DTX/DRX, applied power offset, and/or active spatial elements; Example 2: A network operation state can be associated with a set of configurations for cell DTX/DRX, within multiple sets of configurations; Example 3: A network operation state can be associated with either activation or deactivation of cell DTX/DRX.

In diagram 900 implemented as a method, a UE is provided from a serving cell via higher layer signaling, e.g., RRC, one or multiple network operation states and receives DCI triggering state transition. For example, there can be 3 DTX states (together with the ‘ON’ state), each corresponding to a value for {on-duration, offset, maybe Inactivity Timer}−DCI format 2_9 has 2 bits to indicate 1 of the 3 DTX states (or the ‘ON’ state). In another example, there can be an active and inactive states of a DTX configuration—DCI format 2_9 has one bit to indicate. The DRX state can be similarly indicated in the DCI format 2_9.

A search space set group indication may also be provided (e.g., UE may switch to more/less frequent PDCCH monitoring). For instance, the UE (e.g., UE 116) can be provided a set of configurations for the search space set group to be associated with each of the network operation state, and when the DCI triggers the network operation state transition, the UE applies the corresponding associated set of configurations for the search space set group, wherein e.g., the set of configurations for the search space set group can at least include a periodicity and/or a time offset and/or an interval and/or a duration for determining the monitoring occasions for the PDCCH. In one particular example, the search space set group can at least include the search space set for receiving the PDCCH carrying the DCI trigger, such that the UE may expect different patterns for the monitoring occasions of the PDCCH carrying the DCI trigger in different network operation states.

In addition to indicating the network operation state index, the triggering DCI can be further augmented by at least one of the following: The DCI includes timer values for indicating valid duration of currently indicated network operation state. There can be a default network operation state defined and the UE switches to the default network operation state upon expiration of the timer. The DCI can indicate a series of M network state indices to UE using a single DCI. The UE will go through a sequence of M network state transitions. There may be a default valid duration timer applied to all the network operation states, a separate valid duration timer is configured for each state using higher layer signaling, or a set of valid duration timer values are indicated along with the M indicated network operation states using DCI. The DCI indicated validity duration timer may be an index from a set of candidate values configured via higher-layer signaling. The DCI may indicate network states for N cell groups/TRPs to the UE using a single DCI. The DCI can indicate the index of network state and the next PDCCH monitoring occasion for state transition. The DCI can indicate to skip performing PDCCH monitoring in the next DTX and/or DRX cycle. The DCI can indicate to cancel the non-active period for the next DTX and/or DRX cycle and treat it as an active period. There can be a default network operation state defined and the UE switches to the default network operation state if the UE missed reception(s) of the DCI. For one instance, the default network operation state is the “ON” state for cell DTX and/or cell DRX. For another instance, if the UE missed reception(s) of DCI for a number of consecutive occasions, the switching to default state is triggered. For yet another instance, if the UE missed reception(s) of DCI for a time duration (e.g., a configured duration, or a DTX/DRX cycle, or an on duration for DTX/DRX), the switching to default state is triggered.

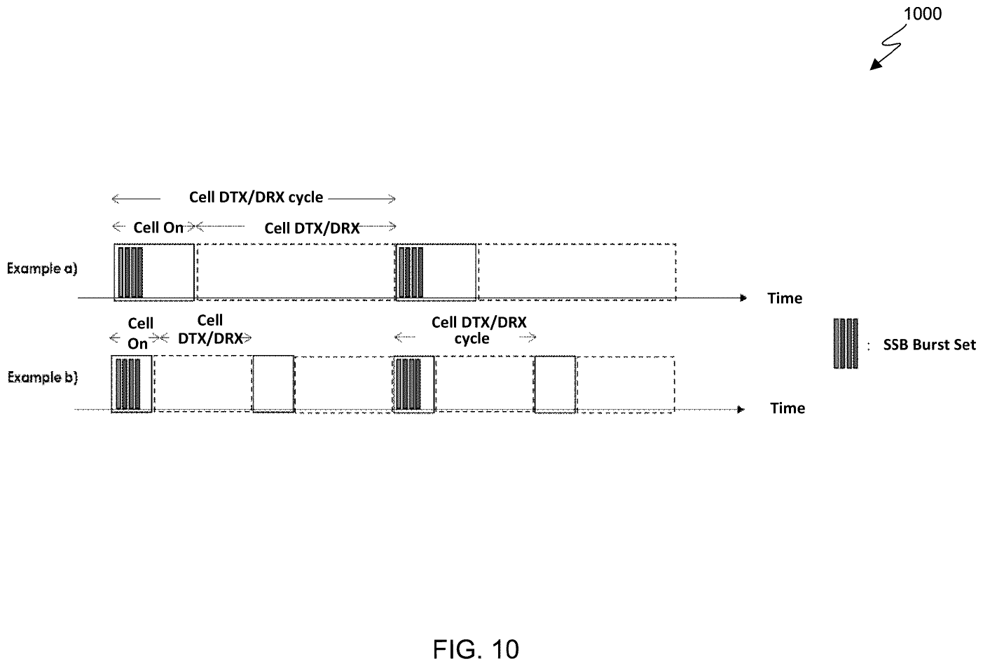

FIG. 10 illustrates a diagram 1000 of an example cell DTX/DRX configuration. The embodiment of the diagram 1000 illustrated in FIG. 10 is for illustration only. FIG. 10 does not limit the scope of this disclosure to any particular implementation of the diagram 1000.

In embodiments, cell DTX/DRX configuration at least includes Cell On duration timer and Cell DTX/DRX cycle, where for example, SSB periodicity is an integer multiple of Cell DTX/DRX cycle, e.g., Cell DTX/DRX cycle from {oneEighth, oneFourth, oneHalf, one}. From UE perspective, an SSB burst is contained in a Cell On duration as well as SIB, paging occasion (PO), and PRACH. The start timing of active period can be referenced to those DL/UL signal/channels, i.e., start timing aligned or with an offset value, e.g., the start timing of Cell On duration can be referenced to SSB burst. Cell DRX configuration can be assumed the same as Cell DTX configuration, Cell DRX can be separately configured, or Cell DRX is not configured and left up to network implementation.

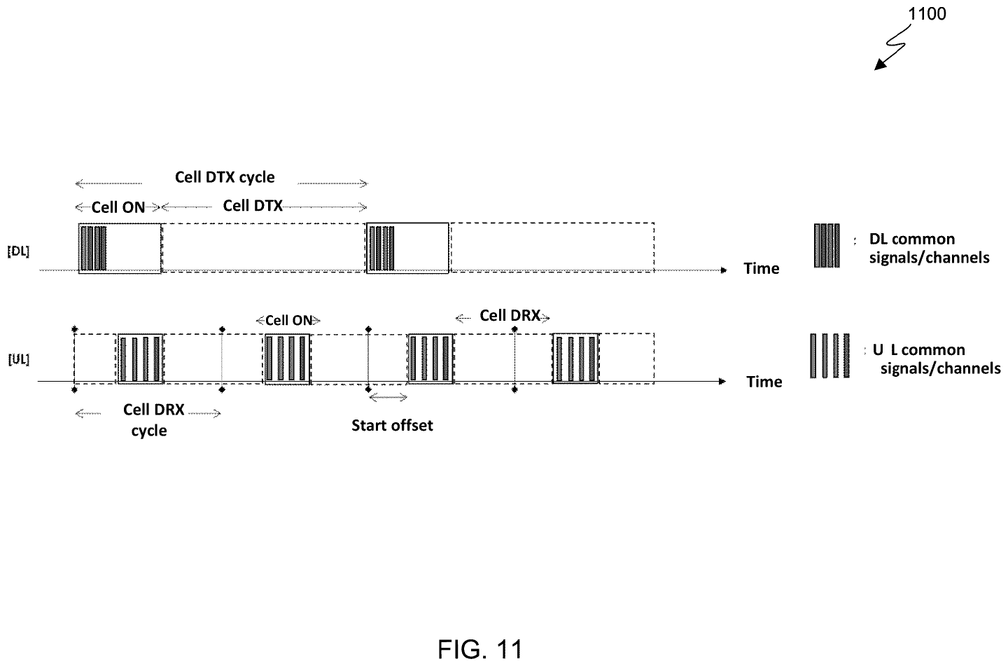

FIG. 11 illustrates a diagram 1100 of examples of separate configurations for Cell DTX/DRX. The embodiment of the diagram 1100 illustrated in FIG. 11 is for illustration only. FIG. 11 does not limit the scope of this disclosure to any particular implementation of the diagram 1100.

Cell DTX can be configured via Cell DTX cycle/offset, Cell DTX On duration. A UE (e.g., UE 116) is not expected to receive DL common signals/channels (SSB/SI/cell common PDCCH) as well as some UE specific signals/channels during cell DTX (e.g., time duration outside the Cell DTX On duration). For legacy UE or UE in IDLE/INACTIVE state, a broadcast signal, e.g., MIB (or SIB), may indicate that whether SI/paging is transmitted in a certain Cell DTX/DRX occasion.

Cell DRX can be configured via Cell DRX cycle/offset, Cell DRX On duration. UE is not expected to transmit PRACH or semi-statically configured UE specific signals/channels such as at least one of semi-persistent scheduling (SPS), SRS, configured grant PUSCH (CG-PUSCH), or PUCCH/PUSCH carrying SR, and/or CSI report, etc. Some exceptions can be provisioned. For instance, a UE which has already measured the cell before DTX/DRX and initiated a handover (HO) procedure may continue to proceed random access procedure by transmitting PRACH, regardless of whether the cell is in DTX/DRX or not.

Cell DTX/DRX timing can be configured in reference to an SSB burst, system frame number (SFN), PO, etc. The parameters in the configuration can be common for cell DTX and DRX. The timing for cell DTX/DRX can refer to some absolute timing (e.g., SFN) or other configured timing (e.g., SSB, PO). The timing for cell DRX can also refer to cell DTX, if they are configured separately.

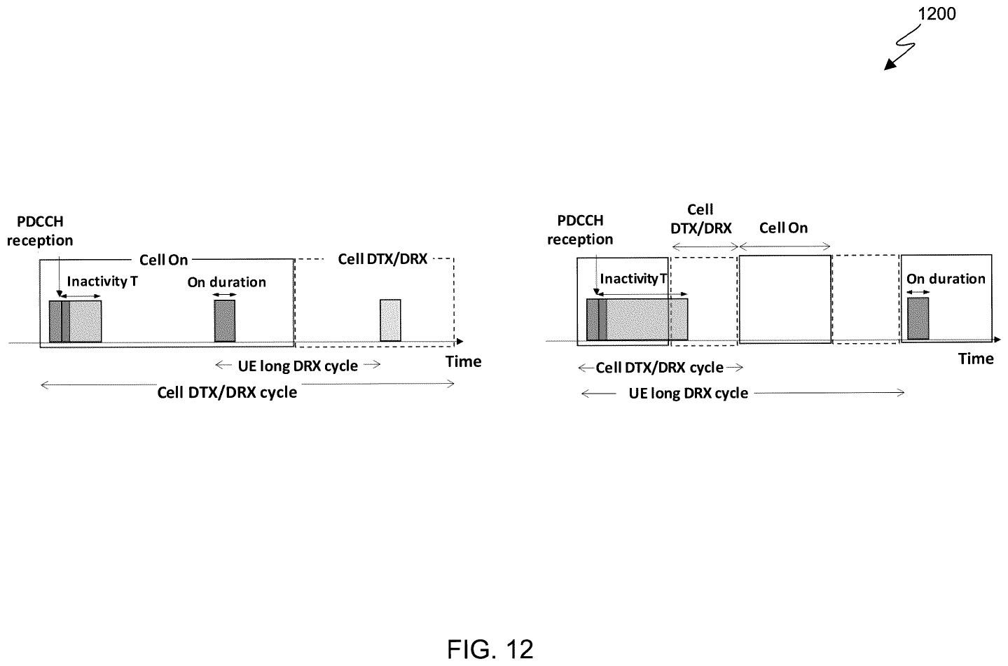

FIG. 12 illustrates a diagram 1100 of cell DTX/DRX and UE DRX alignment. The embodiment of the diagram 1200 illustrated in FIG. 12 is for illustration only. FIG. 12 does not limit the scope of this disclosure to any particular implementation of the diagram 1200.

In one embodiment, a UE (e.g., UE 116) can be provided a first configuration for cell DTX/DRX and a second configuration for UE DRX at the same time.

In one example, a UE does not expect misaligned configurations between the first configuration for cell DTX/DRX and the second configuration for UE DRX, e.g., the UE assumes the ON duration of a (long) UE DRX cycle is confined within an active period (or ON duration) of a cell DTX cycle.

In another example, the misaligned configurations between the first configuration for cell DTX/DRX and the second configuration for UE DRX can be expected by the UE, and the UE procedure for operation with such misalignment can take an example as follow.

In one example, when a duration is determined as a UE DRX ON duration and a Cell DTX/DRX non-active duration (or outside the ON duration), the UE can choose one of the configurations by specified rules with potential conditions. For instance, the UE can assume to operate following the UE DRX ON duration and ignore the cell DTX/DRX non-active duration. For another instance, the UE can assume to operate following the cell DTX/DRX non-active duration and ignore the UE DRX ON duration.

In another example, when a duration is determined as a UE DRX ON duration and a Cell DTX/DRX non-active duration (or outside the ON duration), the UE can assume only UE DRX ON durations (or partial ones) within the active periods (or ON duration) of cell DTX/DRX are valid.

In another example, when a duration is determined as a UE DRX ON duration and a Cell DTX/DRX non-active duration (or outside the ON duration), the UE can assume the active period (or ON duration) of cell DTX/DRX can be extended to include the UE DRX ON durations (e.g., especially for partial one)

In one example, a UE follows UE DRX configuration during a Cell On duration, including at least one of UE DRX cycle, On duration, and/or Inactivity timer. If a UE DRX On duration (or UE DRX Inactivity timer) starts during Cell On duration and ends during Cell DTX/DRX duration (or non-active period), the UE assumes that Cell On duration is extended until the end of UE DRX On duration (or expiration of UE DRX Inactivity timer). Alternatively, UE DRX On duration (or UE DRX Inactivity timer) is shortened.

In further examples, a UE follows Cell DTX/DRX during a Cell DTX/DRX duration, i.e., a UE does not monitor PDCCH during Cell DTX/DRX even if there is a UE DRX cycle occasion. There can be cell-level inactivity timer signaled to UE. Cell-level inactivity timer overrides UE DRX inactivity timer when UE DRX inactivity timer is expected to finish in a Cell DTX/DRX duration.

In more examples, for UE long DRX, after a UE received a PDCCH in the ON duration, the UE extends in active state and keeps monitoring for PDCCH until the expiry of an inactivity timer. Even though the ON duration is within an active period, the extended ON duration based on inactivity timer can exceed the boundary of active period and overlap with non-active period.

In examples, the UE can only extend the UE DRX ON duration up to the ending of active period of the cell DTX. In one instance, this example holds when the PDCCH schedules DL or UL transmission(s).

In another example, the UE assumes the cell DTX active period is extended till the UE DRX inactivity timer expires. In one instance, this example holds when the PDCCH schedules DL or UL transmission(s).

In yet another example, the UE does not extend the cell DTX active period or shorten the UE DRX inactivity timer. In one instance, this example holds when the PDCCH schedules sidelink (SL) transmission(s).

In further example, the UE can be indicated by the gNB (e.g., 102) a new timer to override or adjust the inactivity timer. In one instance, the new timer can be provided by higher layer parameter (e.g., together with cell DTX/DRX configuration). In another instance, the new timer can be provided in the PDCCH that triggers the inactivity timer.

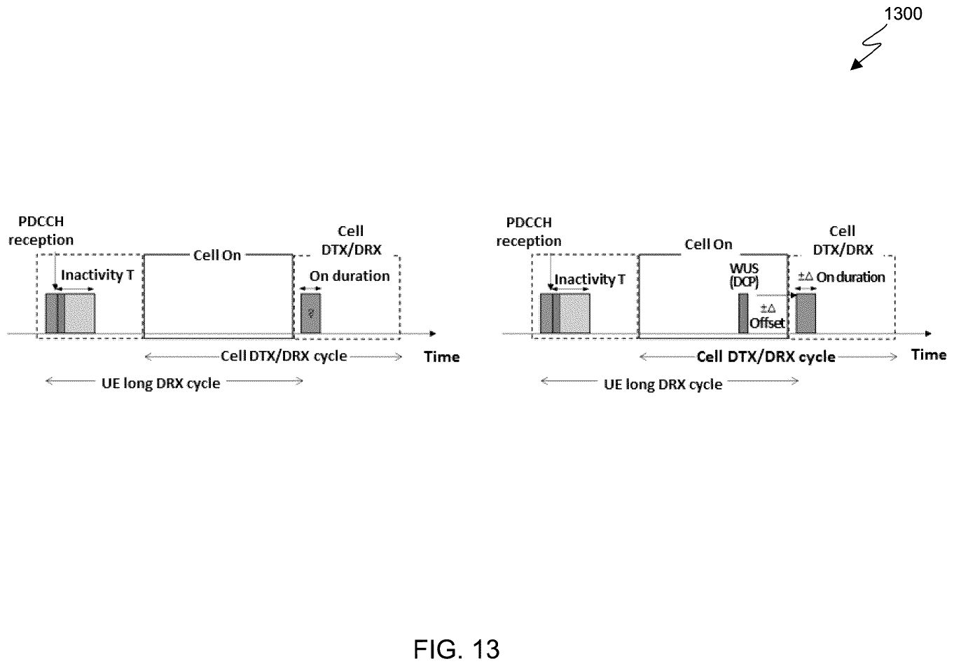

FIG. 13 illustrates a diagram 1300 of a UE wakeup during cell DTX/DRX. The embodiment of the diagram 1300 illustrated in FIG. 13 is for illustration only. FIG. 13 does not limit the scope of this disclosure to any particular implementation of the diagram 1300.

In one example, when there is no UE DRX On duration (or active duration) falls in a Cell DTX/DRX On duration, the UE considers that the UE DRX configuration is invalid and follows Cell DTX/DRX. In another example, the UE (e.g., UE 116) considers that the Cell DTX/DRX configuration is invalid and follows UE DRX. In yet another example, the UE (e.g., UE 116) is indicated by the serving gNB (e.g., 102) which configuration to follow.

In one example, when the UE is provided a first configuration for cell DTX/DRX and a second configuration for UE DRX at the same time, the UE follows the operation according to the configuration for cell DTX/DRX, and ignore the configuration for UE DRX. In another example, when the UE is provided a first configuration for cell DTX/DRX and a second configuration for UE DRX at the same time, the UE follows the operation according to the configuration for UE DRX, and ignore the configuration for cell DTX/DRX.

In one example, when there is no UE DRX On duration falls in a Cell On duration but there is PDCCH monitoring occasion configured for the UE for WUS of the corresponding UE DRX On duration falling in a Cell DTX/DRX, UE DRX configuration is considered valid even if UE DRX On duration falls in a Cell DTX/DRX. For one further consideration, WUS (e.g., DCI format 2-6) can be extended to indicate ±Δ offset values to the start of UE DRX On duration (in addition to RRC configured ps-Offset) and ±Δ On duration (in addition to the RRC configured drx-onDurationTimer). If a UE misses downlink control information of power saving (DCP), the UE may skip DRX On duration, which falls in a Cell DTX/DRX even if ps-WakeUp is set. Alternatively, a UE may be separately configured with ps-WakeUp for Cell On duration and Cell DTX/DRX.

In one example, L1 indication can be used for validation of the ON duration—e.g., if a WUS (e.g., DCI format 2-6) indicates wake-up in the ON duration, the UE assumes active period is extended to include the ON duration. Furthermore, L1 indication-based shifting or extending the ON duration—e.g., L1 signal/channel indicates an extra offset and/or duration on top of the RRC configured ones, to change the location/duration of the ON duration.

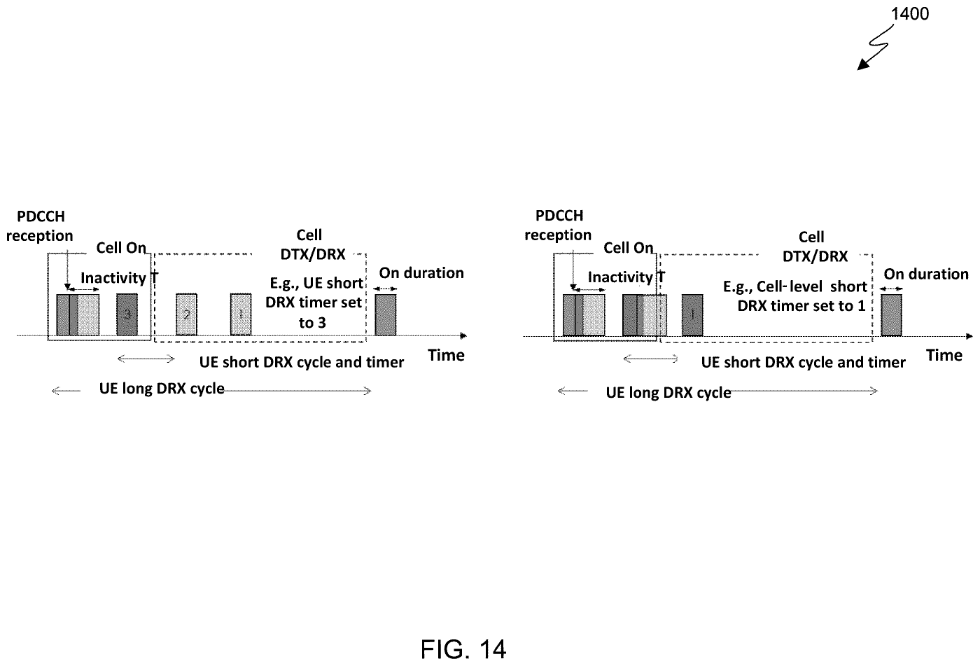

FIG. 14 illustrates a diagram 1400 of UE short DRX handling. The embodiment of the diagram 1400 illustrated in FIG. 14 is for illustration only. FIG. 14 does not limit the scope of this disclosure to any particular implementation of the diagram 1400.

In one example, when short DRX cycle is configured, if there was any data activity, the UE would switch to short DRX cycle and follows short cycle for certain amount of time. It's possible that UE's ON duration in short DRX cycle fall into or overlap with the non-active period of the cell DTX, even though the ON duration in long DRX cycle is within the active period. In this case, the UE can follow at least one of the following examples.

In one example, the UE can consider it as an invalid case, and ignore the operation of short DRX.

In another example, the UE drops the ON durations in cell non-active period. In one further consideration, this example can hold if the ON duration is extended by an inactivity timer.

In yet another example, the UE assumes the cell active period is extended till the short DRX timer expires.

In yet another example, the gNB (e.g., gNB 102) can indicate a new timer to override or adjust the short DRX timer (e.g., the new timer as an offset to the short DRX timer). In one instance, the new timer can be provided by higher layer parameter (e.g., together with cell DTX/DRX configuration). In another instance, the new timer can be provided in the PDCCH that triggers the short DRX timer.

In one example, a UE early terminates short DRX cycles, even if the UE's short DRX timer has not reached yet, if remaining short DRX occasion(s) fall in a non-active period of a cell DTX/DRX. Short DRX early termination can be further conditioned on whether an inactivity timer is triggered in the last UE DRX On duration before Cell DTX/DRX transition, e.g., no early termination or set a separate short DRX timer for Cell DTX/DRX duration. If UE's inactivity timer is running upon expiration of Cell On duration, the UE continues counting the inactivity timer (assuming that the cell is On) or shorten it. There can be separate (e.g., cell-level) short DRX timer and inactivity timer applied during Cell DTX/DRX, apart from UE-specific short DRX timer and inactivity timer.

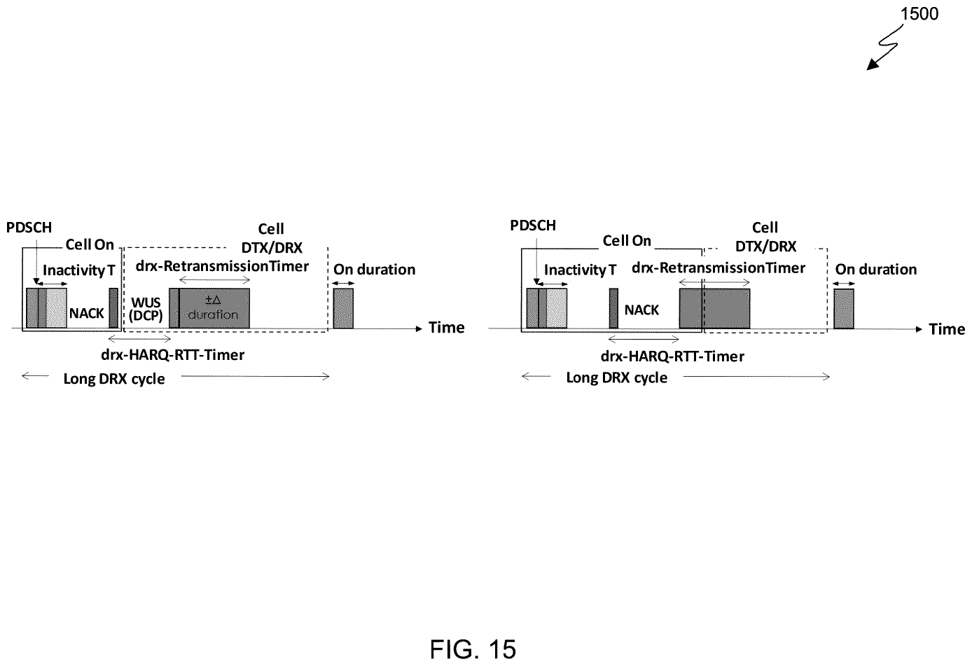

FIG. 15 illustrates a diagram 1500 of handling HARQ RTT and retransmission timers. The embodiment of the diagram 1500 illustrated in FIG. 15 is for illustration only. FIG. 15 does not limit the scope of this disclosure to any particular implementation of the diagram 1500.

In one example, when retransmission of PDSCH happens, the UE starts a timer drx-HARQ-RTT-TimerDL for waiting for the retransmission, and another timer drx-RetransmissionTimerDL for waking up to receive the retransmission. It's possible that the duration defined by drx-HARQ-RTT-TimerDL and/or drx-RetransmissionTimerDL fall in or overlap with the non-active period for cell DTX/DRX. For this example, the UE can follow at least one of the following examples.

In one example, the UE can consider this as an invalid case, and ignore the operation for timer drx-HARQ-RTT-TimerDL and/or drx-RetransmissionTimerDL.

In another example, the UE drops or shortens the drx-RetransmissionTimerDL in cell non-active period.

In yet another example, the UE assumes the cell active period is extended till the drx-RetransmissionTimerDL expires. Consequently, the UE continues monitoring PDCCH until the timer expires.

In yet another example, the UE can be indicated a new timer to override or adjust the drx-RetransmissionTimerDL/drx-HARQ-RTT-TimerDL. In one instance, the new timer can be provided by higher layer parameter (e.g., together with cell DTX/DRX configuration). In another instance, the new timer can be provided in the PDCCH that triggers the timer or another PDCCH at the beginning of drx-RetransmissionTimerDL.

In one example, when retransmission of PUSCH happens, the UE starts a timer drx-HARQ-RTT-TimerUL for waiting for the retransmission, and another timer drx-RetransmissionTimerUL for waking up to receive the retransmission. It's possible that the duration defined by drx-HARQ-RTT-TimerUL and/or drx-RetransmissionTimerUL fall in or overlap with the non-active period for cell DTX/DRX. For this example, the UE can follow at least one of the following examples.

In one example, the UE can consider this as an invalid case, and ignore the operation for timer drx-HARQ-RTT-TimerUL and/or drx-RetransmissionTimerUL.

In another example, the UE drops or shortens the drx-RetransmissionTimerUL in cell non-active period.

In yet another example, the UE assumes the cell active period is extended till the drx-RetransmissionTimerUL expires. Consequently, the UE continues monitoring PDCCH until the timer expires.

In yet another example, the UE can be indicated a new timer to override or adjust the drx-RetransmissionTimerUL/drx-HARQ-RTT-TimerUL. In one instance, the new timer can be provided by higher layer parameter (e.g., together with cell DTX/DRX configuration). In another instance, the new timer can be provided in the PDCCH that triggers the timer or another PDCCH at the beginning of drx-RetransmissionTimerUL.

In one example, when retransmission of PSSCH happens, the UE starts a timer drx-HARQ-RTT-TimerSL for waiting for the retransmission, and another timer drx-RetransmissionTimerSL for waking up to receive the retransmission. It's possible that the duration defined by drx-HARQ-RTT-TimerSL and/or drx-RetransmissionTimerSL fall in or overlap with the non-active period for cell DTX/DRX. For this example, the UE can follow at least one of the following examples.

In one example, the UE can consider this as an invalid case, and ignore the operation for timer drx-HARQ-RTT-TimerSL and/or drx-RetransmissionTimerSL.

In another example, the UE drops or shortens the drx-RetransmissionTimerSL in cell non-active period.

In yet another example, the UE maintains the operation of cell DTX/DRX without extending the active period.

In yet another example, the UE assumes the cell active period is extended till the drx-RetransmissionTimerSL expires. Consequently, the UE continues monitoring PSCCH until the timer expires.

In yet another example, the UE can be indicated a new timer to override or adjust the drx-RetransmissionTimerSL/drx-HARQ-RTT-TimerSL. In one instance, the new timer can be provided by higher layer parameter (e.g., together with cell DTX/DRX configuration). In another instance, the new timer can be provided in the PDCCH that triggers the timer or another PDCCH at the beginning of drx-RetransmissionTimerSL.

In one example, if a UE starts drx-HARQ-RTT-Timer which ends in a Cell DTX/DRX, a UE monitors DCP at the expiry of drx-HARQ-RTT-Timer to get the confirmation from serving gNB (e.g., gNB 102). DPC may also indicate ±Δ On duration (in addition to drx-RetransmissionTimer). Alternatively, a UE transitions into on state upon expiry of drx-HARQ-RTT-Timer (or vice versa). PUSCH retransmission can be similarly understood (except that the drx-HARQ-RTT-TimerUL starts from the first symbol of PUSCH transmission).

In another example, if a UE starts drx-RetransmissionTimer which overlaps with Cell DTX/DRX, the UE shortens drx-RetransmissionTimer at the expiry of Cell On duration. Alternatively, the UE continues drx-RetransmissionTimer even during Cell DTX/DRX duration. Further alternatively, a UE is indicated by the serving gNB via DCI drx-RetransmissionTimer overriding RRC configured value. The DCI may also indicate whether to send further HARQ ACK is allowed in the following cell DTX/DRX.

In one example, a UE can be configured with multiple cells, and at most two configurations can be configured for UE DRX, wherein each cell can be applied with one configuration for the UE DRX. The UE can be provided with at least one configurations for cell DTX/DRX.

For one example, there can be a single cell DTX/DRX configuration, and the UE assumes every cell is configured with the same configuration for cell DTX/DRX operation. For one instance, for each cell, the UE performs according to one example in this disclosure independently, wherein the ON duration and/or active duration and/or non-active duration for UE DRX is according to the corresponding UE DRX configuration. For another instance, for each cell, the UE performs according to one example in this disclosure, wherein the ON duration and/or active duration and/or non-active duration for UE DRX is according to all the UE DRX configurations.

For another example, there can be multiple cell DTX/DRX configurations (e.g., two), and the UE assumes every cell is configured with one of configurations for cell DTX/DRX operation. For one instance, for each cell, the UE performs according to one example in this disclosure independently, wherein the ON duration and/or active duration and/or non-active duration for cell DTX/DRX is according to the corresponding cell DTX/DRX configuration, and ON duration and/or active duration and/or non-active duration for UE DRX is according to the corresponding UE DRX configuration.

In one embodiment, a sidelink transmission or reception can be impacted by the cell DTX and/or DRX operation.

For one instance, the sidelink transmission or reception can be with mode 1 operation, wherein a gNB provides grant for resource allocation for the sidelink transmission or reception.

For one example, the UE may not receive a PDCCH carrying a DCI format 3_0 and/or a DCI format 3_1 in the non-active period of the cell DTX.

For another example, the UE may not receive a PDCCH carrying a DCI format 3_0 and/or a DCI format 3_1 in the non-active period of the cell DTX, if the DCI format schedules a new sidelink transmission (e.g., the drx-RetransmissionTimerSL is not running).

For yet another example, the UE may expect to receive a PDCCH carrying a DCI format 3_0 and/or a DCI format 3_1 in the non-active period of the cell DTX.

For yet another example, the UE may expect to receive a PDCCH carrying a DCI format 3_0 and/or a DCI format 3_1 in the non-active period of the cell DTX, if the DCI format schedules a retransmitted sidelink transmission (e.g., the drx-RetransmissionTimerSL is running).

For one example, sidelink HARQ-ACK feedback transmitted in a PUCCH and/or a PUSCH may not be impacted by a cell DRX operation, e.g., a UE may expect to transmit a PUCCH and/or a PUSCH that carries the sidelink HARQ-ACK feedback.

For another example, the UE may not transmit a PUCCH and/or a PUSCH that carries the sidelink HARQ-ACK feedback.

In one embodiment, a transmission or reception of aperiodic CSI-RS can be impacted by the cell DTX and/or DRX operation. The aperiodic CSI-RS can be triggered by a DCI format.

For one instance, the aperiodic CSI-RS can be for CSI reporting purpose.

For one example, a UE may not receive the DCI format triggering the aperiodic CSI-RS in the non-active period of the cell DTX.

For one example, a UE may expect to receive the DCI format triggering the aperiodic CSI-RS in the non-active period of the cell DTX.

For one example, a UE may not receive the aperiodic CSI-RS in the non-active period of the cell DTX.

For another example, a UE may not receive the aperiodic CSI-RS in the non-active period of the cell DTX, if the DCI format that triggering the aperiodic CSI-RS is not expected to be received (e.g., also located in the non-active period of the cell DTX).

For yet another example, a UE may expect to receive the aperiodic CSI-RS in the non-active period of the cell DTX, if the DCI format that triggering the aperiodic CSI-RS is received (e.g., located in the active period of the cell DTX).

In one embodiment, a transmission of uplink control information (UCI) by a PUCCH and/or a PUSCH can be impacted by the cell DTX and/or DRX operation. For one example, a UE determines the content of the UCI first (e.g., multiplexing from SR, and/or LRR, and/or CSI report, and/or HARQ-ACK feedback), and then determines whether to transmit the UCI based on the cell DTX and/or DRX operation. For one instance, if the UCI includes SR, and the channel (e.g., PUCCH and/or PUSCH) carrying the UCI overlaps or is within the non-active period of a DRX operation, the UE does not transmit the UCI. For another instance, if the UCI includes positive SR, and the channel (e.g., PUCCH and/or PUSCH) carrying the UCI overlaps or is within the non-active period of a DRX operation, the UE does not transmit the UCI. For yet another instance, if the UCI includes LRR, and the channel (e.g., PUCCH and/or PUSCH) carrying the UCI overlaps or is within the non-active period of a DRX operation, the UE does not transmit the UCI. For another instance, if the UCI includes positive LRR, and the channel (e.g., PUCCH and/or PUSCH) carrying the UCI overlaps or is within the non-active period of a DRX operation, the UE does not transmit the UCI. For yet another instance, if the UCI includes CSI report, and the channel (e.g., PUCCH and/or PUSCH) carrying the UCI overlaps or is within the non-active period of a DRX operation, the UE does not transmit the UCI. For yet another instance, if the UCI includes HARQ-ACK feedback only, the UE transmits the UCI, regardless of whether the channel (e.g., PUCCH and/or PUSCH) carrying the UCI overlaps or is within the non-active period of a DRX operation.

In one embodiment, a transmission of uplink control information (UCI) by a PUCCH and/or a PUSCH can be impacted by the cell DTX and/or DRX operation. For one example, a UE determines the content of the UCI first (e.g., multiplexing from SR, and/or LRR, and/or CSI report, and/or HARQ-ACK feedback), and then determines whether to transmit the UCI based on the cell DTX and/or DRX operation. For one instance, if the UCI includes SR, and the channel (e.g., PUCCH and/or PUSCH) carrying the UCI overlaps or is within the non-active period of a DRX operation, the UE does not transmit the UCI. For another instance, if the UCI includes positive SR, and the channel (e.g., PUCCH and/or PUSCH) carrying the UCI overlaps or is within the non-active period of a DRX operation, the UE does not transmit the UCI. For yet another instance, if the UCI includes LRR, and the channel (e.g., PUCCH and/or PUSCH) carrying the UCI overlaps or is within the non-active period of a DRX operation, the UE does not transmit the UCI. For another instance, if the UCI includes positive LRR, and the channel (e.g., PUCCH and/or PUSCH) carrying the UCI overlaps or is within the non-active period of a DRX operation, the UE does not transmit the UCI. For yet another instance, if the UCI includes CSI report, and the channel (e.g., PUCCH and/or PUSCH) carrying the UCI overlaps or is within the non-active period of a DRX operation, the UE does not transmit the UCI. For yet another instance, if the UCI includes HARQ-ACK feedback only, the UE transmits the UCI, regardless of whether the channel (e.g., PUCCH and/or PUSCH) carrying the UCI overlaps or is within the non-active period of a DRX operation.

In another embodiment, for multiple instances for the transmission of a PUCCH (e.g., for UCI reporting), for example, the multiple instances are repetitions of the PUCCH transmission, the PUCCH transmissions can be impacted by the cell DTX and/or DRX operation.

For one example, if a subset of the multiple instances overlap or are within the non-active period of a DRX operation, the UE may not transmit the subset of the multiple instances for the PUCCH. For one instance, this example can be further subject to the condition that the PUCCH carries UCI including at least SR. For another instance, this example can be further subject to the condition that the PUCCH carries UCI including at least positive SR. For yet another instance, this example can be further subject to the condition that the PUCCH carries UCI including at least LRR. For yet another instance, this example can be further subject to the condition that the PUCCH carries UCI including at least positive LRR. For yet another instance, this example can be further subject to the condition that the PUCCH carries UCI including at least CSI report. For yet another instance, this example can be further subject to the condition that the PUCCH carries UCI not including HARQ-ACK feedback.

In another embodiment, for multiple instances for the transmission of a PUCCH (e.g., for UCI reporting), for example, the multiple instances are repetitions of the PUCCH transmission, the PUCCH transmissions can be impacted by the cell DTX and/or DRX operation.

For one example, if a subset of the multiple instances overlap or are within the non-active period of a DRX operation, the UE may not transmit the subset of the multiple instances for the PUCCH. For one instance, this example can be further subject to the condition that the PUCCH carries UCI including at least SR. For another instance, this example can be further subject to the condition that the PUCCH carries UCI including at least positive SR. For yet another instance, this example can be further subject to the condition that the PUCCH carries UCI including at least LRR. For yet another instance, this example can be further subject to the condition that the PUCCH carries UCI including at least positive LRR. For yet another instance, this example can be further subject to the condition that the PUCCH carries UCI including at least CSI report. For yet another instance, this example can be further subject to the condition that the PUCCH carries UCI not including HARQ-ACK feedback.

For another example, if a subset of the multiple instances overlap or are within the non-active period of a DRX operation, the UE may transmit the subset of the multiple instances for the PUCCH. For one instance, this example can be further subject to the condition that the PUCCH carries UCI including at least SR, and the PUCCH transmission in the subset of the multiple instances does not include the at least SR. For another instance, this example can be further subject to the condition that the PUCCH carries UCI including at least positive SR, and the PUCCH transmission in the subset of the multiple instances does not include the at least positive SR. For yet another instance, this example can be further subject to the condition that the PUCCH carries UCI including at least LRR, and the PUCCH transmission in the subset of the multiple instances does not include the at least LRR. For yet another instance, this example can be further subject to the condition that the PUCCH carries UCI including at least positive LRR, and the PUCCH transmission in the subset of the multiple instances does not include the at least positive LRR. For yet another instance, this example can be further subject to the condition that the PUCCH carries UCI including at least CSI report, and the PUCCH transmission in the subset of the multiple instances does not include the at least CSI report. For yet another instance, this example can be further subject to the condition that the PUCCH carries UCI including HARQ-ACK feedback only.

In yet another embodiment, the PUCCH cell switching can be impacted by the cell DTX and/or DRX operation.

For one example, a UE expects the configuration for PUCCH cell switching is compatible with the cell DRX operations in the multiple cells. For instance, the transmission occasion of the PUCCH is within an active period of the corresponding cell in the cell switching. For another example, if a transmission occasion of the PUCCH overlaps or is within a non-active period of the corresponding cell in the cell switching, the UE can drop the PUCCH transmission. For one instance, this example can be further subject to the condition that the PUCCH carries UCI including at least SR. For another instance, this example can be further subject to the condition that the PUCCH carries UCI including at least positive SR. For yet another instance, this example can be further subject to the condition that the PUCCH carries UCI including at least LRR. For yet another instance, this example can be further subject to the condition that the PUCCH carries UCI including at least positive LRR. For yet another instance, this example can be further subject to the condition that the PUCCH carries UCI including at least CSI report. For yet another instance, this example can be further subject to the condition that the PUCCH carries UCI not including HARQ-ACK feedback.

For yet another example, if a transmission occasion of the PUCCH overlaps or is within a non-active period of the corresponding cell in the cell switching, the UE can still perform the PUCCH transmission. For one instance, this example can be further subject to the condition that the PUCCH carries UCI including at least SR, and the PUCCH transmission does not include the at least SR. For another instance, this example can be further subject to the condition that the PUCCH carries UCI including at least positive SR, and the PUCCH transmission does not include the at least positive SR. For yet another instance, this example can be further subject to the condition that the PUCCH carries UCI including at least LRR, and the PUCCH transmission does not include the at least LRR. For yet another instance, this example can be further subject to the condition that the PUCCH carries UCI including at least positive LRR, and the PUCCH transmission does not include the at least positive LRR. For yet another instance, this example can be further subject to the condition that the PUCCH carries UCI including at least CSI report, and the PUCCH transmission does not include the at least CSI report. For yet another instance, this example can be further subject to the condition that the PUCCH carries UCI including HARQ-ACK feedback only.

In one embodiment, deferring the HARQ-ACK feedback for SPS PDSCH can be impacted by the cell DTX and/or DRX operation.

For one example, if the transmission occasion of the deferred HARQ-ACK feedback overlaps or is within a non-active period of a cell DRX operation, the transmission of the deferred HARQ-ACK feedback is dropped.

For another example, if the transmission occasion of the deferred HARQ-ACK feedback overlaps or is within a non-active period of a cell DRX operation, the UE may not defer the HARQ-ACK feedback transmission.

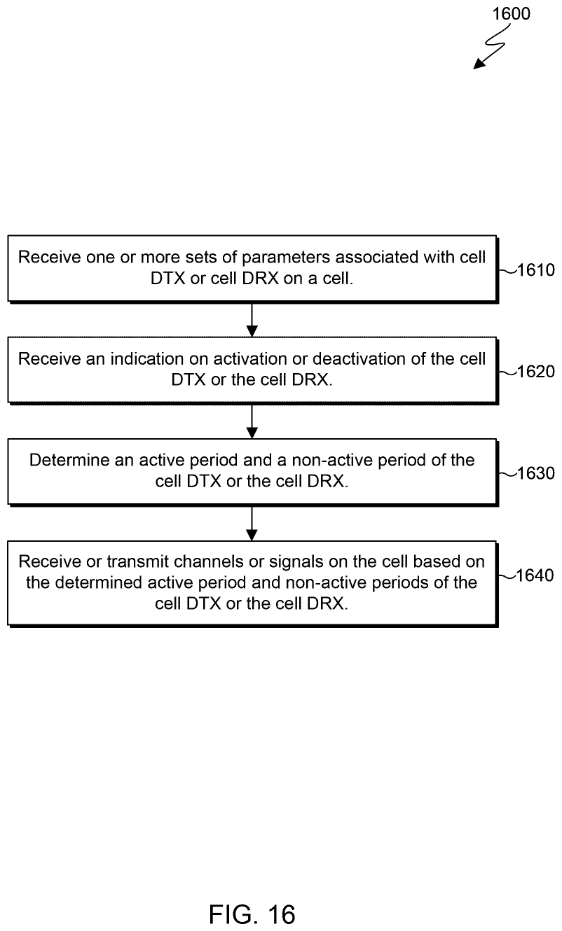

FIG. 16 illustrates an example method 1600 performed by a UE in a wireless communication system according to embodiments of the present disclosure. The method 1600 of FIG. 16 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1600 is for illustration only and other embodiments can be used without departing from the scope of the present disclosure.

The method 1600 begins with the UE receiving one or more sets of parameters associated with cell DTX or cell DRX on a cell (1610). For example, in 1610, the one or more sets of parameters include cycle, start offset, and on-duration timer parameters and the cell DTX and the cell DRX share common parameters.

The UE then receives an indication on activation or deactivation of the cell DTX or the cell DRX (1620). For example, in 1620, the indication is in DCI. In various embodiments, the UE may receive information related to a search space set to PDCCHs, where a PDCCH from the PDCCHs provides a DCI format, the DCI format provides the indication on activation or deactivation of the cell DTX or the cell DRX, and indications on activation or deactivation of the cell DTX and activation or deactivation of the cell DRX are separate indications.

The UE then determines an active period and a non-active period of the cell DTX or cell DRX (1630). For example, in 1630, the respective determination are made based on the indication on activation or deactivation of cell DTX and based on the indication on activation or deactivation of cell DRX. In various embodiments, a start of a cell DTX on-duration timer or a cell DRX on-duration timer is determined with reference to a SFN.

The UE then receives or transmits channels or signals on the cell based on the determined active period and non-active periods of the cell DTX or the cell DRX. In various embodiments, channels or signals not received during the non-active period of the cell DTX include at least one of PDCCHs according to a UE-specific search space, PDCCHs according to a common search space, and SPS PDSCHs. In various embodiments, channels or signals not transmitted during the non-active period of the cell DRX include at least one of a periodic and semi-persistent CSI reporting, periodic and semi-persistent SRSs, and a SR. In various embodiments, reception of PDCCHs is continued during the non-active period of the cell DTX when a DRX retransmission timer is running.

In various embodiments, in response to identification that (i) multiple PUCCHs would overlap in a slot or (ii) one or more PUCCHs and one or more PUSCHs would overlap in a slot, and at least one of the PUCCHs or the PUSCHs would overlap with the non-active period of the cell DRX on the cell, the UE may further determine to multiplex one or more types of UCI first and to transmit a physical channel providing the one or more types of UCI second.

Any of the above variation embodiments can be utilized independently or in combination with at least one other variation embodiment.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by a user equipment (UE), the method comprising:
receiving:
information related to one or more sets of parameters associated with cell discontinuous transmission (DTX) or cell discontinuous reception (DRX) on a cell, wherein:
the one or more sets of parameters include a cycle, a start offset, or an on-duration timer, and
the cell DTX and the cell DRX share common parameters, and
an indication for activation or deactivation of the cell DTX or the cell DRX;
determining:
one of:
an active period and a non-active period of the cell DTX based on the indication for activation or deactivation of cell DTX, or
an active period and a non-active period of the cell DRX based on the indication for activation or deactivation of cell DRX, and
a start of the cell DTX on-duration timer or the cell DRX on-duration timer based on a system frame number (SFN); and
one of:
receiving channels or signals on the cell based on the determined active and non-active periods of the cell DTX; or
transmitting channels or signals on the cell based on the determined active and non-active periods of the cell DRX.

2. The method of claim 1, further comprising:
receiving information related to a search space set for receiving physical downlink control channels (PDCCHs), wherein:
a PDCCH from the PDCCHs provides a downlink control information (DCI) format,
the DCI format provides the indication for activation or deactivation of the cell DTX or the cell DRX, and
the indication for activation or deactivation of the cell DTX is separate from the indication for activation or deactivation of the cell DRX.

3. The method of claim 1, wherein:
the UE receives the channels or signals on the cell based on the determined active and non-active periods of the cell DTX, and
channels or signals not received during the non-active period of the cell DTX include at least one of:
physical downlink control channels (PDCCHs) according to any UE-specific search space,
PDCCHs according to at least one common search space,
semi-persistent scheduling (SPS) physical downlink shared channels (PDSCHs),
periodic synchronization signal blocks (SSBs), and
periodic system information blocks (SIBs).

4. The method of claim 1, wherein:
the UE transmits the channels or signals on the cell based on the determined active and non-active periods of the cell DRX, and
channels or signals not transmitted during the non-active period of the cell DRX include at least one of:
a channel that provides only a periodic or a semi-persistent channel state information (CSI) report,
a periodic and semi-persistent sounding reference signal (SRS), and
a channel that provides only a scheduling request (SR).

5. The method of claim 1, wherein:
the UE transmits the channels or signals on the cell based on the determined active and non-active periods of the cell DRX, and
channels or signals transmitted during the non-active period of the cell DRX include a physical random access channel (PRACH).

6. The method of claim 1, wherein reception of physical downlink control channels (PDCCHs) continues during the non-active period of the cell DTX when a DRX retransmission timer is running.

7. The method of claim 1, further comprising, in response to identifying that:
(i) multiple physical uplink control channels (PUCCHs) would overlap in a slot, or (ii) one or more PUCCHs and one or more physical uplink shared channels (PUSCHs) would overlap in a slot, and
at least one of the PUCCHs or the PUSCHs would overlap with the non-active period of the cell DRX on the cell,
determining:
one or more first PUCCHs or PUSCHs for multiplexing one or more types of uplink control information (UCI) first, and
one or more second PUCCHs or PUSCHs, from the one or more first PUCCHs or PUSCHs, for transmission second.

8. A user equipment (UE) comprising:
a transceiver configured to receive:
information related to one or more sets of parameters associated with cell discontinuous transmission (DTX) or cell discontinuous reception (DRX) on a cell, wherein:
the one or more sets of parameters include a cycle, a start offset, or an on-duration timer, and
the cell DTX and the cell DRX share common parameters, and
an indication for activation or deactivation of the cell DTX or the cell DRX; and
a processor operably coupled to the transceiver, the processor configured to determine:
one of:
an active period and a non-active period of the cell DTX based on the indication for activation or deactivation of cell DTX, or
an active period and a non-active period of the cell DRX based on the indication for activation or deactivation of cell DRX, and
a start of the cell DTX on-duration timer or the cell DRX on-duration timer based on a system frame number (SFN); and
wherein the transceiver is further configured to:
receive channels or signals on the cell based on the determined active and non-active periods of the cell DTX, or
transmit channels or signals on the cell based on the determined active and non-active periods of the cell DRX.

9. The UE of claim 8, wherein the transceiver is further configured to receive:
information related to a search space set for receiving physical downlink control channels (PDCCHs), wherein:
a PDCCH from the PDCCHs provides a downlink control information (DCI) format,
the DCI format provides the indication for activation or deactivation of the cell DTX or the cell DRX, and
the indication for activation or deactivation of the cell DTX is separate from the indication for activation or deactivation of the cell DRX.

10. The UE of claim 8, wherein:
the transceiver is configured to receive the channels or signals on the cell based on the determined active and non-active periods of the cell DTX, and
channels or signals not received during the non-active period of the cell DTX include at least one of:
physical downlink control channels (PDCCHs) according to any UE-specific search space,
PDCCHs according to at least one common search space,
semi-persistent scheduling (SPS) physical downlink shared channels (PDSCHs),
periodic synchronization signal blocks (SSBs), and
periodic system information blocks (SIBs).

11. The UE of claim 8, wherein:
the transceiver is configured to transmit the channels or signals on the cell based on the determined active and non-active periods of the cell DRX, and
channels or signals not transmitted during the non-active period of the cell DRX include at least one of:
a channel that provides only a periodic and a semi-persistent channel state information (CSI) reporting,
periodic and semi-persistent sounding reference signals (SRSs), and
a channel that provides only a scheduling request (SR).

12. The method of claim 1, wherein:
the UE transmits the channels or signals on the cell based on the determined active and non-active periods of the cell DRX, and
channels or signals transmitted during the non-active period of the cell DRX include a physical random access channel (PRACH).

13. The UE of claim 8, wherein reception of physical downlink control channels (PDCCHs) continues during the non-active period of the cell DTX when a DRX retransmission timer is running.

14. The UE of claim 8, wherein the processor is further configured to, in response to identification that:
(i) multiple physical uplink control channels (PUCCHs) would overlap in a slot or (ii) one or more PUCCHs and one or more physical uplink shared channels (PUSCHs) would overlap in a slot, and
at least one of the PUCCHs or the PUSCHs would overlap with the non-active period of the cell DRX on the cell,
determine:
one or more first PUCCHs or PUSCHs for multiplexing one or more types of uplink control information (UCI) first, and
one or more second PUCCHs or PUSCHs, from the one or more first PUCCHs or PUSCHs, for transmission second.

15. A base station (BS) comprising:
a transceiver configured to transmit:
information related to one or more sets of parameters associated with cell discontinuous transmission (DTX) or cell discontinuous reception (DRX) on a cell, wherein:
the one or more sets of parameters include a cycle, a start offset, or an on-duration timer, and
the cell DTX and the cell DRX share common parameters, and
an indication for activation or deactivation of the cell DTX or the cell DRX; and
a processor operably coupled to the transceiver, the processor configured to determine:
one of:
an active period and a non-active period of the cell DTX based on the indication for activation or deactivation of cell DTX, or
an active period and a non-active period of the cell DRX based on the indication for activation or deactivation of cell DRX, and
a start of the cell DTX on-duration timer or the cell DRX on-duration timer based on a system frame number (SFN),
wherein the transceiver is further configured to:
transmit channels or signals on the cell based on the determined active and non-active periods of the cell DTX, or
receive channels or signals on the cell based on the determined active and non-active periods of the cell DRX.

16. The BS of claim 15, wherein the transceiver is further configured to transmit:
information related to a search space set for receiving physical downlink control channels (PDCCHs), wherein:
a PDCCH from the PDCCHs provides a downlink control information (DCI) format,
the DCI format provides the indication for activation or deactivation of the cell DTX or the cell DRX, and
the indication for activation or deactivation of the cell DTX is separate from the indication for activation or deactivation of the cell DRX.

17. The BS of claim 15, wherein:
the transceiver is configured to transmit the channels or signals on the cell based on the determined active and non-active periods of the cell DTX, and
channels or signals not transmitted during the non-active period of the cell DTX include at least one of:
physical downlink control channels (PDCCHs) according to any UE-specific search space,
PDCCHs according to at least one common search space,
semi-persistent scheduling (SPS) physical downlink shared channels (PDSCHs),
periodic synchronization signal blocks (SSBs), and
periodic system information blocks (SIBs).

18. The BS of claim 15, wherein:
the transceiver is configured to receive the channels or signals on the cell based on the determined active and non-active periods of the cell DRX, and
channels or signals not received during the non-active period of the cell DRX include at least one of:
a channel that provides only a periodic and a semi-persistent channel state information (CSI) reporting,
periodic and semi-persistent sounding reference signals (SRSs), and
a channel that provides only a scheduling request (SR).

19. The BS of claim 15, wherein:
the BS receives the channels or signals on the cell based on the determined active and non-active periods of the cell DRX, and
channels or signals transmitted during the non-active period of the cell DRX include a physical random access channel (PRACH).

20. The BS of claim 15, wherein transmission of physical downlink control channels (PDCCHs) continues during the non-active period of the cell DTX when a DRX retransmission timer is running.
